(19) United States
(12) Patent Application Publication
(10) Pub. No.: US 2025/0055153 A1
(43) Pub. Date: Feb. 13, 2025

(54) RECHARGEABLE BATTERY

(71) Applicant: SAMSUNG SDI CO., LTD., Yongin-si (KR)

(72) Inventors: Taeyoon LEE, Yongin=si (KR); Bo Hyun KIM, Yongin-si (KR); Duckhyun KIM, Yongin-si (KR); Woonsuk JANG, Yongin-si (KR)

(21) Appl. No.: 18/735,375

(22) Filed: Jun. 6, 2024

(30) Foreign Application Priority Data
Aug. 10, 2023 (KR) 10-2023-0105065

(51) Int. Cl. H01M 50/533; H01M 50/107; H01M 50/152; H01M 50/538

(52) U.S. Cl. CPC H01M 50/533; H01M 50/107; H01M 50/152; H01M 50/538

(57) ABSTRACT

A rechargeable battery includes a hexagonal column-shaped can that includes a top portion and a side portion; an electrode assembly in the can and in which a plurality of electrodes having different widths are stacked along a width direction of the rechargeable battery; and a cap plate that is coupled to an end portion of the side portion and seals the can, wherein the electrode assembly includes a plurality of tabs on at least one side along a length direction of the rechargeable battery, and the plurality of tabs include a first set of tabs bent in a first direction and a second set of tabs bent in a second direction different from the first direction.

### CROSS-REFERENCE TO RELATED APPLICATION

This application claims priority to and the benefit of Korean Patent Application No. 10-2023-0105065 filed at the Korean Intellectual Property Office on Aug. 10, 2023, the entire contents of which are incorporated herein by reference.

### BACKGROUND

### 1 Field

Embodiments relate to a rechargeable battery.

### 2. Description of the Related Art

A rechargeable battery may be used as a power source for a small electronic device such as a mobile phone and a laptop computer, and has also recently been used as a power source for driving a motor in a transportation vehicle such as an electric vehicle or a hybrid vehicle. In the latter case, a battery module combining a plurality of rechargeable batteries may be used, and a normal battery module may include a plurality of cylindrical rechargeable batteries.

### SUMMARY

The embodiments may be realized by providing a rechargeable battery including a hexagonal column-shaped can that includes a top portion and a side portion; an electrode assembly in the can and in which a plurality of electrodes having different widths are stacked along a width direction of the rechargeable battery; and a cap plate that is coupled to an end portion of the side portion and seals the can, wherein the electrode assembly includes a plurality of tabs on at least one side along a length direction of the rechargeable battery, and the plurality of tabs include a first set of tabs bent in a first direction and a second set of tabs bent in a second direction different from the first direction.

Each electrode of the plurality of electrodes may have a quadrangular sheet shape, a long side of each electrode of the plurality of electrodes may be parallel to the length direction of the rechargeable battery, and a short side of each of the plurality of electrodes may be parallel to two facing surfaces of six surfaces of the side portion of the can.

Two electrodes at an outermost side among the plurality of electrodes may have a smallest width, an electrode at a center may have a greatest width, and widths of the plurality of electrodes gradually may increase from the outermost side toward the center.

The second direction may be a reverse direction relative to the first direction, and a width of the first set of tabs along the first direction and a width of the second set of tabs along the second direction may be each the same as a width of the electrode assembly.

Each tab of the plurality of tabs may include a central cutting groove and a plurality of cutting lines, the first set of tabs may be at one side of the central cutting groove, and the second set of tabs may be at another side of the central cutting groove.

The rechargeable battery may further include a current collecting plate coupled to the plurality of tabs, wherein the plurality of tabs and the current collecting plate may have a hexagonal shape on a plane.

The second direction may be a reverse direction relative to the first direction, and a width of the first set of tabs along the first direction and a width of the second set of tabs along the second direction may be each half a width of the electrode assembly.

A tab of the first set of tabs and a tab of the second set of tabs among the plurality of tabs may overlap each other at a boundary portion between the first set of tabs and the second set of tabs.

The plurality of tabs may include at least one tab at a boundary portion of the second set of tabs and contacting the first set of tabs, and the at least one tab may have a protruding length smaller than that of a tab at a remaining portion other than the boundary portion.

The rechargeable battery may further include a current collecting plate coupled to the plurality of tabs, wherein each tab of the plurality of tabs may include a plurality of cutting lines, and the plurality of tabs and the current collecting plate may have a hexagonal shape or a quadrangular shape on a plane.

The embodiments may be realized by providing a rechargeable battery including a hexagonal column-shaped can that includes a top portion and a side portion; an electrode assembly in the can and in which a plurality of electrodes having different widths are stacked along a width direction of the rechargeable battery; and a cap plate that is coupled to an end portion of the side portion and seals the can, wherein the electrode assembly includes a plurality of tabs on at least one side along a length direction of the rechargeable battery, and the plurality of tabs include six sets of tabs, the six sets of tabs being respectively bent in six different directions.

Each of the plurality of electrodes may have a quadrangular sheet shape, a long side of each of the plurality of electrodes may be parallel to the length direction, and a short side of each of the plurality of electrodes may be parallel to two facing surfaces of the six surfaces of the side portion of the can.

The six different directions may respectively be directions extending inwardly from six sides of the electrode assembly toward a center point of the electrode assembly, and the six sets of tabs may be respectively arranged in a triangle connecting two adjacent corners of the six sides of the electrode assembly and the center point of the electrode assembly.

Each tab of the plurality of tabs may include a plurality of cutting lines, the plurality of tabs may be vertically bent in two sets of tabs among the six sets of tabs, and the plurality of tabs may be bent in an inclined direction in the remaining four sets of tabs among the six sets of tabs.

The plurality of tabs may be at a region outside of and surrounding a central portion of the electrode assembly.

The rechargeable battery may further include a current collecting plate coupled to the plurality of tabs, wherein the plurality of tabs and the current collecting plate may have a hexagonal shape on a plane.

### BRIEF DESCRIPTION OF THE DRAWINGS

Features will be apparent to those of skill in the art by describing in detail exemplary embodiments with reference to the attached drawings in which:

FIG. 1 is a perspective view of a rechargeable battery according to a first embodiment.

FIG. 2 is a cross-sectional view of the rechargeable battery cut along a line A-A of FIG. 1.

FIG. 3 is a cross-sectional view of the rechargeable battery cut along a line B-B of FIG. 1.

FIG. 4 is a perspective view of a can of the rechargeable battery shown in FIG. 1.

FIG. 5 is an exploded perspective view of an electrode assembly and a current collecting plate of the rechargeable battery shown in FIG. 2.

FIG. 6 is a partial enlarged view of the electrode assembly in the rechargeable battery shown in FIG. 3.

FIG. 7 is a partial enlarged view of a first electrode and a second electrode of the electrode assembly shown in FIG. 5.

FIG. 8 is a perspective view showing a bending process of a first tab of the electrode assembly shown in FIG. 4.

FIG. 9 is an enlarged cross-sectional view of a first set of tabs shown in FIG. 8.

FIG. 10 is an enlarged cross-sectional view of a second set of tabs shown in FIG. 8.

FIG. 11 is a perspective view in which a top and a bottom of the electrode assembly shown in FIG. 4 are reversed.

FIG. 12 is a perspective view of an electrode assembly of a rechargeable battery according to a second embodiment.

FIG. 13 is a partially enlarged cross-sectional view of the electrode assembly shown in FIG. 12.

FIG. 14 is an exploded perspective view of an electrode assembly and a current collecting plate of a rechargeable battery according to a third embodiment.

FIG. 15 is a partially enlarged cross-sectional view of an electrode assembly of a rechargeable battery according to a fourth embodiment.

FIG. 16 is a perspective view of an electrode assembly of a rechargeable battery according to a fifth embodiment.

FIG. 17 is a plan view of the electrode assembly shown in FIG. 16.

FIG. 18 is a plan view of an electrode assembly of a rechargeable battery according to a sixth embodiment.

FIG. 19 is a cross-sectional view of the electrode assembly cut along a line C-C of FIG. 18.

FIG. 20 is a schematic diagram of a battery module according to embodiments.

### DETAILED DESCRIPTION

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, with reference to accompanying drawings, embodiments of the present disclosure will be described in detail and thus a person of ordinary skill may easily practice it in the technical field to which the present disclosure belongs. As those skilled in the art would realize, the described embodiments may be modified in various different ways, all without departing from the spirit or scope of the present disclosure.

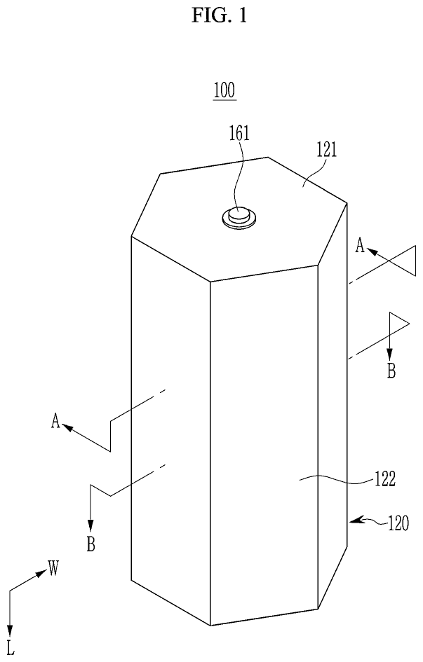

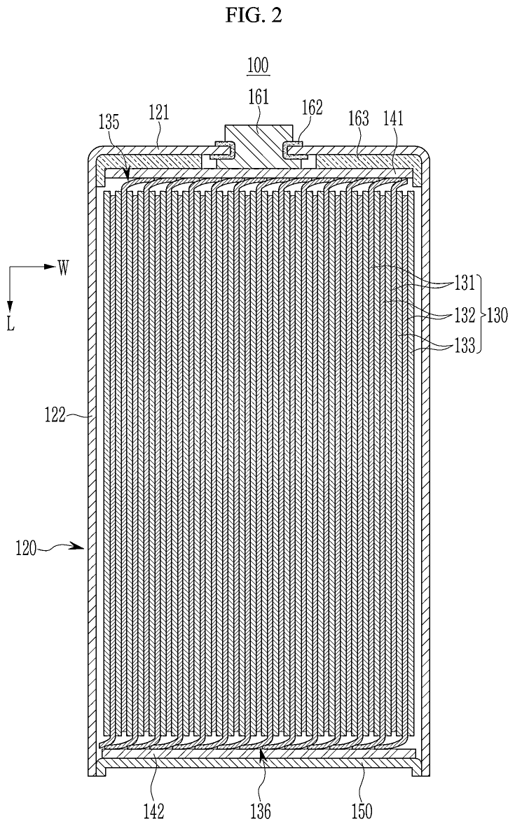

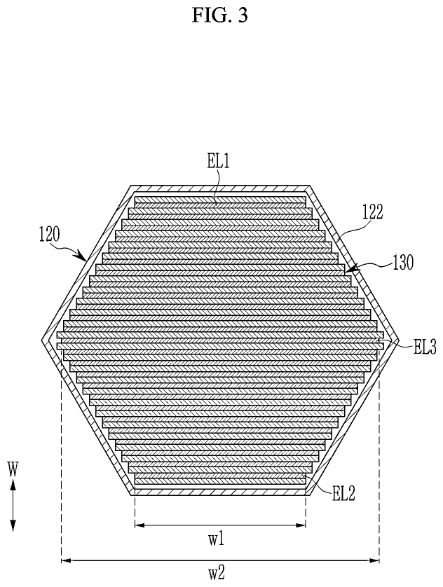

FIG. 1 is a perspective view of a rechargeable battery according to a first embodiment. FIG. 2 is a cross-sectional view of the rechargeable battery cut along a line A-A of FIG. 1, and FIG. 3 is a cross-sectional view of the rechargeable battery cut along a line B-B of FIG. 1.

Referring to FIGS. 1 to 3, the rechargeable battery 100 of the present embodiment may include a can 120, an electrode assembly 130 accommodated inside the can 120, and a cap plate 150 coupled to an end portion or end of the can 120 to seal the can 120. The can 120 and the cap plate 150 may have a hexagonal or hexagonal pillar shape with both sides closed, and the electrode assembly 130 may have a stack-type structure in which a plurality of sheet-type electrodes 131 and 132 are stacked along one direction. Current collecting plates 141 and 142 may be on both sides (upper and lower sides) of the electrode assembly 130.

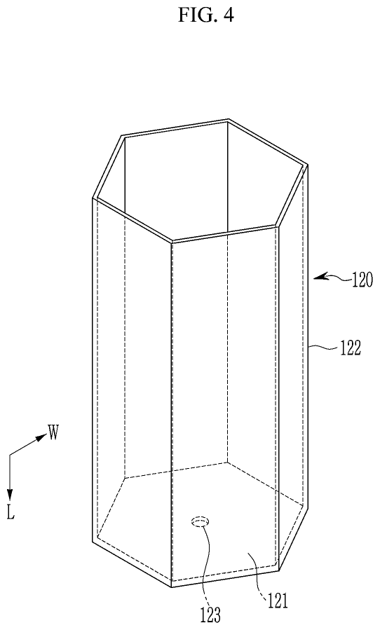

FIG. 4 is a perspective view of a can of the rechargeable battery shown in FIG. 1. The can shown in FIG. 4 is a can in which top and bottom of the can shown in FIG. 1 are inverted.

Referring to FIG. 2 and FIG. 4, the can 120 may include a top portion 121 and a side portion 122 connected to an edge of the top portion 121. The top portion 121 may be referred to as a bottom portion if top and bottom of the can 120 are inverted. The top portion 121 may be a hexagonal metal plate, and the side portion 122 may be or form a hollow hexagonal column-shaped metal pipe. The top portion 121 and the side portion 122 may be integrally connected, and the side portion 122 may be perpendicular to the top portion 121. A shape of the top portion 121 may be a regular hexagon in which all six sides have the same length.

An opening 123 (for installing a rivet terminal 161) may be at a center of the top portion 121. In an implementation, the rechargeable battery 100 may include a terminal having a different type from the rivet terminal 161, and the opening may be omitted at the top portion 121. The can 120 may be made of, e.g., steel, stainless steel, aluminum, an aluminum alloy, or the like.

In an implementation, a direction parallel to a major or central axis of the can 120 may be referred to as a length direction L of the rechargeable battery 100, and a direction in which two surfaces of the side portion 122 face each other among directions perpendicular to the length direction L may be referred to as a width direction W of the rechargeable battery 100. The six surfaces constituting the side portion 122 may include three pairs of surfaces facing each other, and a direction in which any one facing pair of the three pairs of faces may be referred to as the width direction W for convenience. In FIG. 2, the length direction L may be parallel to a vertical direction of the drawings, and the width direction W may be parallel to a horizontal direction of the drawings.

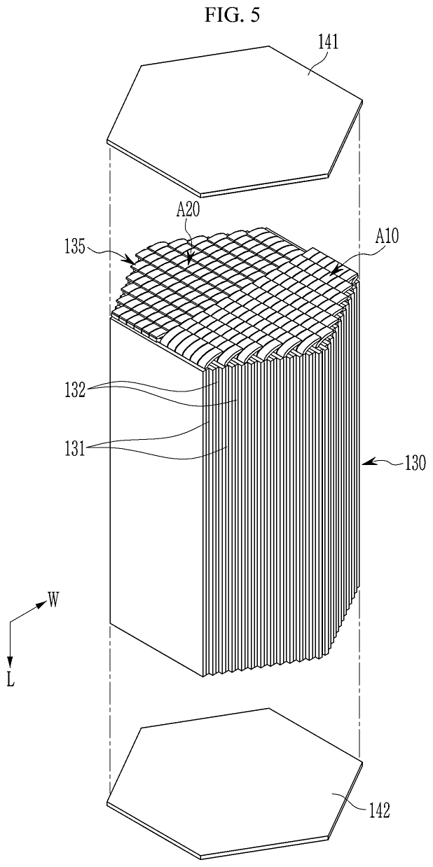

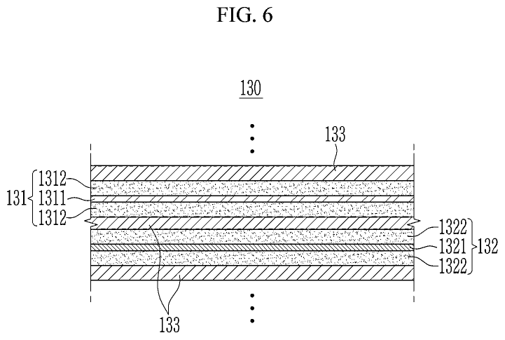

FIG. 5 is an exploded perspective view of the electrode assembly and the current collecting plate of the rechargeable battery shown in FIG. 2, and FIG. 6 is a partial enlarged view of the electrode assembly of the rechargeable battery shown in FIG. 3.

Referring to FIGS. 2, 3, 5, and 6, the electrode assembly 130 may include the plurality of sheet-type electrodes 131 and 132 sequentially stacked along the width direction W of the rechargeable battery 100. Each of the plurality of electrodes 131 and 132 may have a quadrangular sheet shape. A long side of each electrode 131 or 132 may be parallel to the length direction L, and a short side of each electrode 131 or 132 may be parallel to two facing surfaces of the six surfaces constituting the side portion 122.

In an implementation, the electrode assembly 130 may include the plurality of first electrodes 131 and the plurality of second electrodes 132, respectively alternately disposed one by one along the width direction W, and a plurality of separators 133 disposed one by one between the first electrodes 131 and the second electrodes 132 adjacent to each other. Each of the plurality of separators 133 may have a quadrangular sheet shape. The electrode assembly 130 may be accommodated inside the can 120 together with an electrolyte.

The first electrode 131 may include a first substrate 1311 and a first active material layer 1312 on the first substrate 1311. The second electrode 132 may include a second substrate 1321 and a second active material layer 1322 on the second substrate 1321. The separator 133 may insulate the first electrode 131 and the second electrode 132 while allowing movement of a lithium ion.

The first substrate 1311 may include an aluminum (Al) foil, and the first active material layer 1312 may include transition metal oxide, e.g., LiCoO₂, LiNiO₂, LiMn₂O₄, or the like. The second substrate 1321 may include a copper (Cu) foil, a nickel (Ni) foil, or the like, and the second active material layer 1322 may include a carbon material, e.g., graphite. The separator 133 may include a polymer material, e.g., polyethylene, polypropylene, or the like.

The electrode assembly 130 may include the plurality of electrodes 131 and 132 having different widths to form a hexagon on a plane. Hereinafter, the phrase “on a plane” may mean when an object portion is viewed from above.

Two electrodes EL1 and EL2 of FIG. 3 at an outermost side among the plurality of electrodes 131 and 132 constituting the electrode assembly 130 may have the smallest width w1, as illustrated in FIG. 3. An electrode EL3 of FIG. 3 at a center of the electrode assembly 130 may have the greatest width w2, s illustrated in FIG. 3. Widths of the electrodes 131 and 132 may gradually increase from the outside or one end of the electrode assembly 130 toward the center of the electrode assembly 130. In an implementation, the plurality of electrodes 131 and 132 may have the same height or length along the length direction L.

An empty space could be present between the electrode assembly and a corner of the can if the electrode assembly (wound in a cylindrical shape) were to be disposed inside the hexagonal column-shaped can, so that a capacity of the battery could be reduced. In an implementation, in the rechargeable battery 100 of the present embodiment, the electrode assembly 130 may be shaped and arranged to minimize the empty space inside the hexagonal column-shaped can 120, so that an output and a capacity of the battery may be increased.

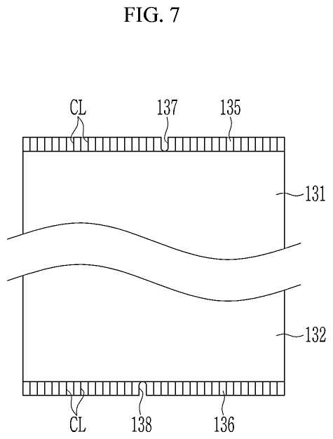

FIG. 7 is a partial enlarged view of the first electrode and the second electrode of the electrode assembly shown in FIG. 5, and shows a state before bending of a first tab and a second tab.

Referring to FIG. 5 and FIG. 7, the electrode assembly 130 may include a plurality of first tabs 135 at one side along the length direction L and a plurality of second tabs 136 at an opposite side thereof (e.g., opposite to the first tabs 135). In an implementation, the first tabs 135 and the second tabs 136 may be opposite to each other along the length direction L.

The first electrode 131 may include the first tabs 135 at one side (e.g., an upper side) along the length direction L, and the second electrode 132 may include the second tabs 136 at an opposite side (e.g., a lower side) of or relative to the first tabs 135. The first tabs 135 may be a portion of the first substrate 1311 of FIG. 6 extended upwardly, and the second tabs 136 may be a portion of the second substrate 1321 of FIG. 6 extended downwardly. A width of the first tabs 135 may be the same as a width of the first electrode 131, and a width of the second tabs 136 may be the same as a width of the second electrode 132.

A plurality of cutting lines CL may be disposed at or in each of the first tabs 135 and the second tabs 136. The plurality of cutting lines CL may be parallel to the length direction L, and may be disposed at a distance from each other along a width direction (a horizontal direction of FIG. 7) of the electrodes 131 and 132. Each of the first tabs 135 and the second tabs 136 may be divided into a plurality of portions by the plurality of cutting lines CL. In an implementation, as illustrated in FIG. 7, the plurality of cutting lines CL may be at equal intervals, or directions of the cutting lines CL and an interval between the cutting lines CL may vary.

In an implementation, central cutting grooves 137 and 138 may be disposed at a center of the first tabs 135 and the second tabs 136, respectively. The first tabs 135 may be divided into two (e.g., left and right) regions or sets of tabs by the central cutting groove 137, and the second tabs 136 may also be divided into two (e.g., left and right) sets of tabs by the central cutting groove 138. A configuration in which the plurality of cutting lines CL and each of the central cutting grooves 137 and 138 are at or in each of the first tabs 135 and the second tabs 136 may facilitate bending of the first tabs 135 and the second tabs 136 during bending processes of the first tabs 135 and the second tabs 136 described below.

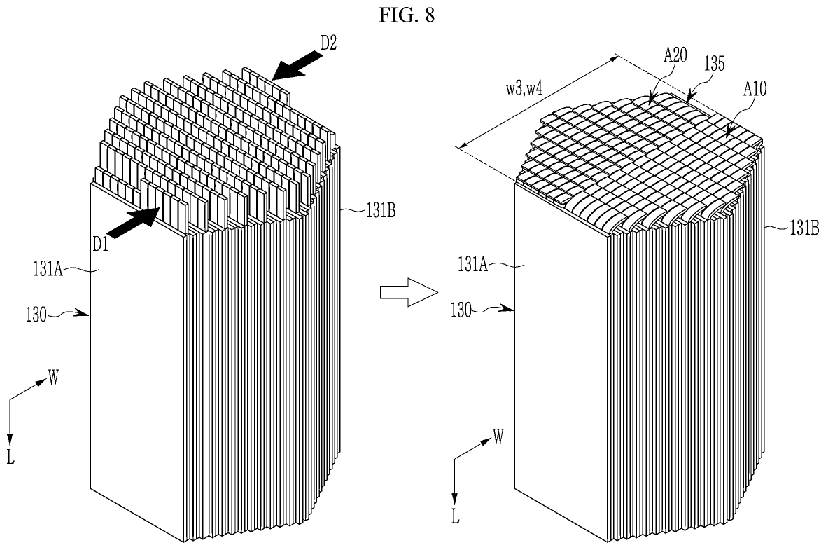

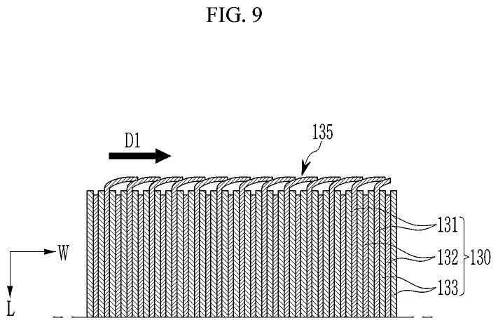

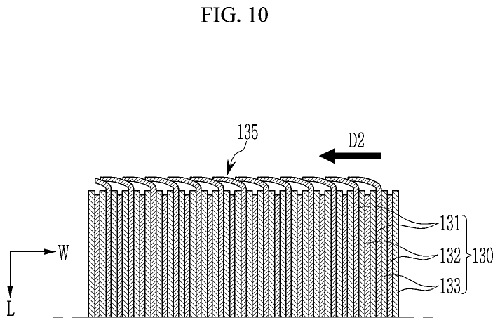

FIG. 8 is a perspective view showing a bending process of the first tab of the electrode assembly shown in FIG. 4, FIG. 9 is an enlarged cross-sectional view of a first set of tabs shown in FIG. 8, and FIG. 10 is an enlarged cross-sectional view of a second set of tabs shown in FIG. 8.

Referring to FIGS. 7 to 10, the plurality of first tabs 135 may include a first set of tabs A10 in which tabs are bent in a first direction D1 to overlap with an adjacent first tab 135, and a second set of tabs A20 in which tabs are bent in a second direction D2 (different from the first direction D1) to overlap with an adjacent first tab 135. Both the first direction D1 and the second direction D2 may be parallel to the width direction W, and may be opposite to each other. In an implementation, the second direction D2 may be a reverse direction to the first direction D1, or may be a negative first direction −D1.

A width w3 of the first set of tabs A10 of FIG. 8 along a bending direction (the first direction D1) may be equal to a width of the electrode assembly 130, and a width w4 of the second set of tabs A20 of FIG. 8 along a bending direction (the second direction D2) may be equal to the width of the electrode assembly 130 (e.g., the first and second sets of tabs A10 and A20 may extend across the entire electrode assembly 130). The first set of tabs A10 may be at one side of the central cutting groove 137, and the second set of tabs A20 may be at the other side of the central cutting groove 137.

For bending of the first tab 135, a jig may be in close contact with the first tab 135 of any one of outermost first electrodes 131A in the first set of tabs A10, and the jig may be moved along the first direction D1 to sequentially press and bend the first tabs 135 of the first set of tabs A10. In an implementation, a moving distance of the jig may be equal to the width of the electrode assembly 130.

Thereafter, a jig may be in close contact with the first tab 135 of an outermost first electrode 131B at an opposite side thereof in the second set of tabs A20, and the jig may be moved along the second direction D2 to sequentially press and bend the first tabs 135 of the second set of tabs A20. In an implementation, a moving distance of the jig may be equal to the width of the electrode assembly 130.

The plurality of first tabs 135 may be overlapped and pressed by the bending to form a substantially flat surface. The first current collecting plate 141 of FIG. 5 may be on the plurality of first tabs 135, and the plurality of first tabs 135 and the first current collecting plate 141 may be integrally fixed by a method such as laser welding or the like. The plurality of first tabs 135 and the first current collecting plate 141 may be physically and electrically connected, and electric currents of the plurality of first electrodes 131 may be collected to the first current collecting plate 141 during charging and discharging of the rechargeable battery 100.

An end portion (a right end portion of FIG. 9) along the bending direction D1 in the first set of tabs A10 and an end portion (a left end portion of FIG. 10) along the bending direction D2 in the second set of tabs A20 among the plurality of first tabs 135 could protrude to or beyond the outside of the electrode assembly 130 along the width direction W. The protruding portion could deteriorate finishing quality of the electrode assembly 130, and could cause a manufacturing defect such as contact with a member having an opposite polarity during an assembly process of the rechargeable battery 100.

In an effort to help prevent this, at least one first tab 135 at the end portion (the right end portion of FIG. 9) along the bending direction D1 in the first set of tabs A10 among the plurality of first tabs 135 and at least one first tab 135 at the end portion (the left end portion of FIG. 10) along the bending direction D2 in the second set of tabs A20 among the plurality of first tabs 135 may have a shorter length than that of other first tabs 135. In an implementation, the plurality of first tabs 135 may not protrude to or beyond the outside of the electrode assembly 130 along the width direction W after the bending.

In an implementation, the plurality of first tabs 135 may all have the same length, and a portion protruding to the outside of the electrode assembly 130 along the width direction W after the bending may be removed by a cutting process.

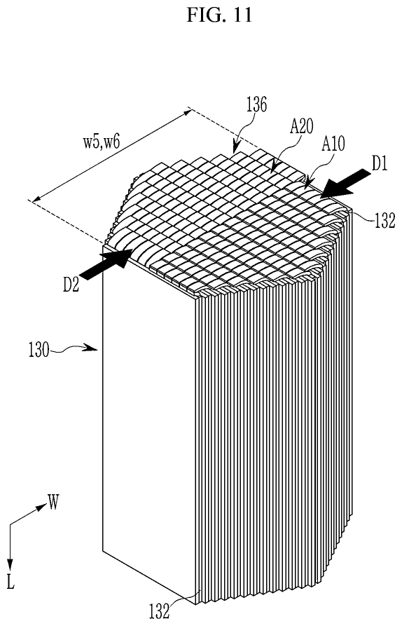

FIG. 11 is a perspective view in which top and bottom of the electrode assembly shown in FIG. 4 are reversed.

Referring to FIG. 7 and FIG. 11, the plurality of second tabs 136 may include a first set of tabs A10 bent in a first direction D1 to overlap with an adjacent second tab 136, and a second set of tabs A20 bent in a second direction D2 (different from the first direction D1) to overlap with an adjacent second tab 136. Both the first direction D1 and the second direction D2 may be parallel to the width direction W, and may be opposite to each other.

A width w5 of the first set of tabs A10 of FIG. 11 along a bending direction (the first direction D1) may be equal to a width of the electrode assembly 130, and a width w6 of the second set of tabs A20 of FIG. 11 along a bending direction (the second direction D2) may be equal to the width of the electrode assembly 130. The first set of tabs A10 may be at one side of the central cutting groove 138, and the second set of tabs A20 may be at the other side of the central cutting groove 138.

The plurality of second tabs 136 may be overlapped and pressed by the bending to form a substantially flat surface. The second current collecting plate 142 of FIG. 5 may be on the plurality of second tabs 136, and the plurality of second tabs 136 and the second current collecting plate 142 may be integrally fixed by a method such as laser welding or the like. The plurality of second tabs 136 and the second current collecting plate 142 may be physically and electrically connected, and electric currents of the plurality of second electrodes 132 may be collected to the second current collecting plate 142 during charging and discharging of the rechargeable battery 100.

Referring to FIG. 8 and FIG. 11, a structure in which the plurality of tabs 135 and 136 are bent to be overlapped with each other may help increase a current collecting efficiency of the electrodes 131 and 132, and may help improve a welding quality between the structure and the current collecting plates 141 and 142. In an implementation, a height of a portion that is not related to the active material layer 1312 or 1322 among a total height of the electrode assembly 130 may be minimized, and a capacity of the rechargeable battery 100 may be increased.

In an implementation, even if an abnormal element (e.g., pressure unevenness of the current collecting plate 141 or 142) were to occur in a process of welding the plurality of tabs 135 and 136 and the current collecting plate 141 or 142, any one of the first and second sets of tabs A10 and A20 may maintain a constant welding quality with the current collecting plate 141 or 142. In an implementation, the first set of tabs A10 and the second set of tabs A20 may have a complementary welding structure.

Referring back to FIG. 2, the first current collecting plate 141 may be coupled to the rivet terminal 161, and the rivet terminal 161 may function as a first terminal (e.g., a positive terminal). The rivet terminal 161 may be inserted into the opening 123 of FIG. 4 of the top portion 121 in a state in which the rivet terminal 161 is surrounded by an insulating gasket 162, and may contact the first current collecting plate 141 inside the can 120 to be charged with the same polarity as that of the first electrode 131. An insulating cover 163 may be inside the can 120 over a portion of the top portion 121 and a portion of the side portion 122. The insulating cover 163 may insulate the first current collecting plate 141 and the can 120.

The cap plate 150 may cover the second current collecting plate 142, and may be coupled to an end portion of the side portion 122 to seal the can 120. The cap plate 150 may be electrically connected to the second current collecting plate 142 to function as a second terminal (e.g., a negative terminal), and the cap plate 150 may be in contact with the can 120 so that the can 120 may also be charged with the same polarity as that of the second electrode 132.

In an implementation, the second current collecting plate 142 may be in contact with the can 120, and the cap plate 150 may maintain an insulating state with the second current collecting plate 142 and the can 120 by an insulating gasket, and may be coupled to an end portion of the side portion 122. In an implementation, the can 120 may function as a second terminal, and the cap plate 150 may be electrically non-polar.

In an implementation, a combined structure of the second current collecting plate 142, the cap plate 150, and the can 120 may vary.

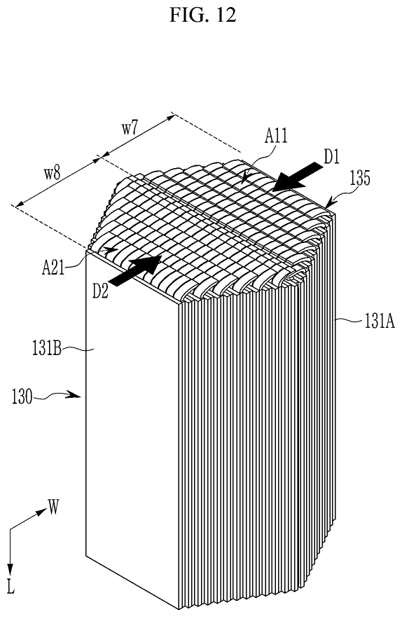

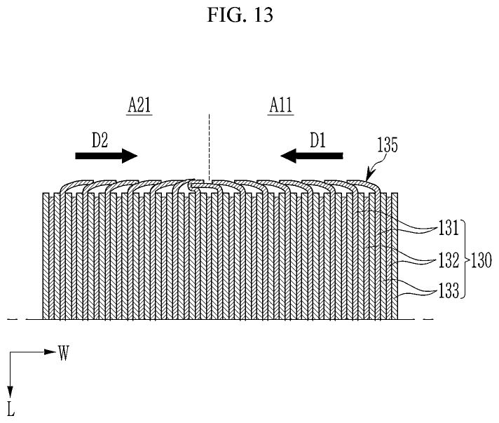

FIG. 12 is a perspective view of an electrode assembly of a rechargeable battery according to a second embodiment, and FIG. 13 is a partially enlarged cross-sectional view of the electrode assembly shown in FIG. 12. The rechargeable battery of the second embodiment may have the same or similar configuration as that of the first embodiment described above except for a plurality of tabs to be described below.

Referring to FIG. 12 and FIG. 13, in the rechargeable battery of the second embodiment, the plurality of first tabs 135 may include a first set of tabs A11 bent in a first direction D1 to overlap with an adjacent first tab 135, and a second set of tabs A21 bent in a second direction D2 (different from the first direction D1) to overlap with an adjacent first tab 135. Both the first direction D1 and the second direction D2 may be parallel to the width direction W, and may be opposite to each other. In an implementation, the second direction D2 may be a reverse direction to the first direction D1, or may be a negative first direction −D1.

A width w7 of the first set of tabs A11 of FIG. 12 according to or measured in a bending direction (the first direction D1) may be half the width of the electrode assembly 130, and a width w8 of the second set of tabs A21 of FIG. 12 according to or measured in a bending direction (the second direction D2) may be half the width of the electrode assembly 130.

For bending of the first tab 135, a jig may be in close contact with the first tab 135 of an outermost first electrode 131A in the first set of tabs A11, and the jig may be moved along the first direction D1 to sequentially press and bend the first tabs 135 of the first set of tabs A11. In an implementation, a moving distance of the jig may be half the width of the electrode assembly 130.

Thereafter, a jig may be in close contact with the first tab 135 of an outermost first electrode 131B at an opposite side thereof in the second set of tabs A21, and the jig may be moved along the second direction D2 to sequentially press and bend the first tabs 135 of the second set of tabs A21. In an implementation, a moving distance of the jig may be half the width of the electrode assembly 130.

At a boundary between the first set of tabs A11 and the second set of tabs A21, the first tab 135 of the second set of tabs A21 may overlap the first tab 135 of the first set of tabs A11. A thickness of the plurality of first tabs 135 after the bending may be slightly increased at the boundary between the first set of tabs A11 and the second set of tabs A21, but may be generally uniform. The plurality of second tabs may have the same configuration as that of the plurality of first tabs 135, and a repeated description thereof may be omitted.

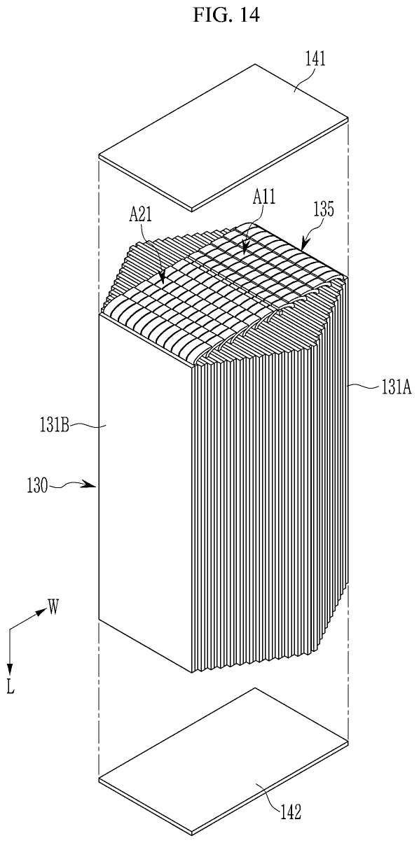

FIG. 14 is an exploded perspective view of an electrode assembly and a current collecting plate of a rechargeable battery according to a third embodiment. The rechargeable battery of the third embodiment may have the same or similar configuration as that of the second embodiment described above except for a plurality of tabs described below.

Referring to FIG. 14, in the rechargeable battery of the third embodiment, the plurality of first tabs 135 may have a constant width. The plurality of first tabs 135 may form a quadrangle (rather than a hexagon) on a plane.

In an implementation, the plurality of first tabs 135 may have the same width as that of only the outermost first electrode 131A or 131B among the plurality of first electrodes 131. In an implementation, left and right portions of the first tabs 135 may be removed in or from the remaining first electrodes 131, e.g., except for two outermost first electrodes 131A and 131B, among the plurality of first electrodes 131.

In a structure where the plurality of first tabs 135 have a hexagonal shape on a plane, a portion protruding from the outside of the electrode assembly 130 along the width direction W may exist at a portion of an edge of the hexagon. The protruding portion could deteriorate finishing quality of the electrode assembly 130, and could cause a manufacturing defect such as contact with a member having an opposite polarity during an assembly process of the rechargeable battery 100.

The rechargeable battery according to the present embodiment may help improve the finishing quality of the electrode assembly 130 by a configuration of the first tabs 135 described above, and may help prevent a manufacturing defect due to the protruding portion of the first tabs 135 during the assembly process. The plurality of second tabs may have the same configuration as that of the plurality of first tabs 135, and a repeated description thereof may be omitted.

In an implementation, in the rechargeable battery of the present embodiment, the current collecting plates 141 and 142 may have a hexagonal shape or a quadrangular shape. In FIG. 14, current collecting plates 141 and 142 having the quadrangular shape are shown as an example. A size of the current collecting plate 141 or 142 having the quadrangular shape may be the same as or similar to a total size of the plurality of tabs 135 or 136.

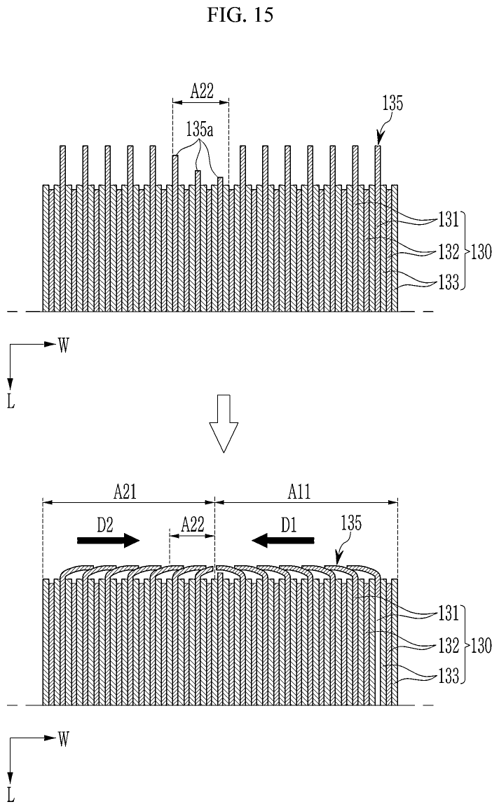

FIG. 15 is a partially enlarged cross-sectional view of an electrode assembly of a rechargeable battery according to a fourth embodiment. The rechargeable battery of the fourth embodiment may have the same or similar configuration as that of any one of the second embodiment and the third embodiment described above except for a plurality of tabs described below.

Referring to FIG. 15, in the rechargeable battery of the fourth embodiment, some of the plurality of first tabs 135 may have a protruding length smaller than that of other ones of first tabs 135. In an implementation, the protruding length may represent a length of the first tab 135 protruding outward from the first electrode 131 (e.g., along the length direction L).

In an implementation, the second set of tabs A21 may be divided into or include a boundary portion A22 contacting or adjacent to the first set of tabs A11 and the remaining portion other than the boundary portion A22, and at least one first tab 135a at the boundary portion A22 may have a protruding length smaller than that of the first tabs 135 at the remaining portion.

A plurality of first tabs 135a may be at the boundary portion A22 of the second set of tabs A21. The plurality of first tabs 135a at the boundary portion A22 may have the same protruding length or different protruding lengths. In an implementation, the plurality of first tabs 135a at the boundary portion A22 may have a smaller protruding length as they approach the first set of tabs A11. FIG. 15 shows the latter case as an example.

According to the above-described configuration, at least one first tab 135a at the boundary portion A22 of the second set of tabs A21 may overlap the first tab 135 of the first set of tabs A11, and an increase in a thickness of the overlapping portion may be suppressed. In an implementation, a thickness of the plurality of first tabs 135 at a boundary between the first set of tabs A11 and the second set of tabs A21 may be similar to a thickness of another portion, and the plurality of first tabs 135 may have a uniform thickness throughout the first set of tabs A11 and the second set of tabs A21. The plurality of second tabs may have the same configuration as that of the plurality of first tabs 135, and a redundant description thereof is omitted.

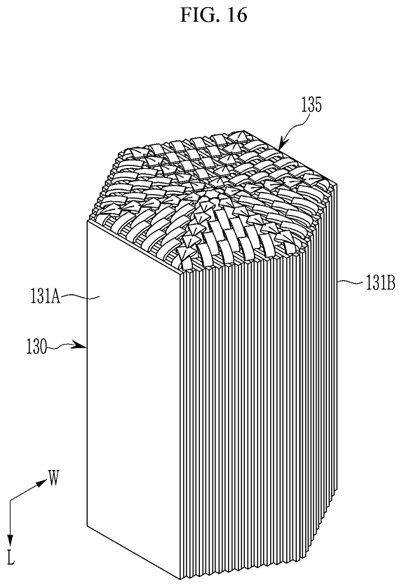

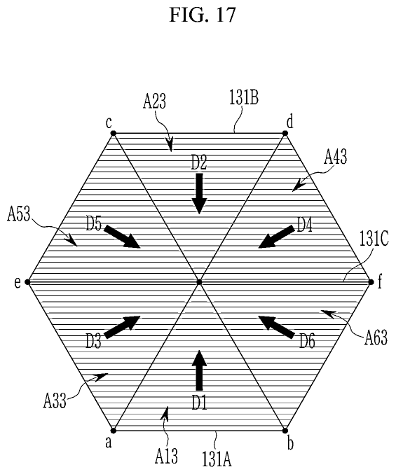

FIG. 16 is a perspective view of an electrode assembly of a rechargeable battery according to a fifth embodiment, and FIG. 17 is a plan view of the electrode assembly shown in FIG. 16. The rechargeable battery of the fifth embodiment may have the same or similar configuration as that of the first embodiment described above except for a plurality of tabs to be described below.

Referring to FIG. 16 and FIG. 17, in the rechargeable battery of the fifth embodiment, the plurality of first tabs 135 may include six sets of tabs A13, A23, A33, A43, A54, and A63 bent in six different directions D1-D6. The six different directions D1-D6 may be directions (e.g., extending inwardly and orthogonally) from six sides of the electrode assembly 130 toward a center point of the electrode assembly 130. The six sets of tabs A13, A23, A33, A43, A54, and A63 may each be in a triangular region connecting two (e.g., adjacent) corners of the six sides of the electrode assembly 130 and the center point of the electrode assembly 130.

In an implementation, one outermost first electrode 131A among the plurality of first electrodes 131 may have a first corner (a point a) and a second corner (a point b), and the other outermost first electrode 131B may have a third corner (a point c) and a fourth corner (a point d). A first electrode 131C at a central portion of the electrode assembly 130 may have a fifth corner (a point e) and a sixth corner (a point f). The first to sixth corners a, b, c, d, e, and f may correspond to six corners of the electrode assembly 130 on a plane.

The first set of tabs A13 may be in a triangular region connecting the first corner (the point a), the second corner (the point b), and the center point of the electrode assembly 130. The second set of tabs A23 may be in a triangular region connecting the third corner (the point c), the fourth corner (the point d), and the center point of the electrode assembly 130.

In the first set of tabs A13, the plurality of first tabs 135 may be bent in the first direction D1, and in the second set of tabs A23, the plurality of first tabs 135 may be bent in the second direction D2. The first direction D1 may be a direction extending inwardly from the outermost first electrode 131A of the first set of tabs A13 toward the center point of the electrode assembly 130, and the second direction D2 may be a negative first direction −D1.

The third set of tabs A33 may be in a triangular region connecting the first corner (the point a), the fifth corner (the point e), and the center point of the electrode assembly 130. The fourth set of tabs A43 may be in a triangular region connecting the fourth corner (the point d), the sixth corner (the point f), and the center point of the electrode assembly 130.

In the third set of tabs A33, the plurality of first tabs 135 may be bent in the third direction D3, and in the fourth set of tabs A43, the plurality of first tabs 135 may be bent in the fourth direction D4. The third direction D3 may be a direction extending inwardly from one side of the electrode assembly 130 connecting the first corner (the point a) and the fifth corner (the point e) toward the center point of the electrode assembly 130, and the fourth direction D4 may be a negative third direction −D3.

The fifth set of tabs A53 may be in a triangular region connecting the third corner (the point c), the fifth corner (the point e), and the center point of the electrode assembly 130. The sixth set of tabs A63 may be in a triangular region connecting the second corner (the point b), the sixth corner (the point f), and the center point of the electrode assembly 130.

In the fifth set of tabs A53, the plurality of first tabs 135 may be bent in the fifth direction D5, and in the sixth set of tabs A63, the plurality of first tabs 135 may be bent in the sixth direction D6. The fifth direction D5 may be a direction extending inwardly from one side of the electrode assembly 130 connecting the third corner (the point c) and the fifth corner (the point e) toward the center point of the electrode assembly 130, and the sixth direction D6 may be a negative fifth direction −D5.

The first tabs 135 may be vertically bent in the first set of tabs A13 and the second set of tabs A23, and the first tabs 135 may be obliquely bent in an inclined direction in the third to sixth sets of tabs A33, A43, A53, and A63. The first tabs 135 may include a plurality of portions by the plurality of cutting lines CL of FIG. 7, and the first tab s135 may be easily bent in the inclined direction even if a force is applied to the first tabs 135 in the inclined direction by a jig.

In the rechargeable battery according to the present embodiment, the plurality of first tabs 135 may be bent from six sides of the electrode assembly 130 toward the center point of the electrode assembly 130. In an implementation, it is possible to prevent a portion of the first tab 135 from protruding from a portion of an edge of the hexagon to or beyond the outside of the electrode assembly 130 without removing the portion of the first tab 135. Therefore, finishing quality of the electrode assembly 130 may be improved, and a manufacturing defect may be prevented during an assembly process of the rechargeable battery. The plurality of second tabs may have the same configuration as that of the plurality of first tabs 135, and a repeated description thereof may be omitted.

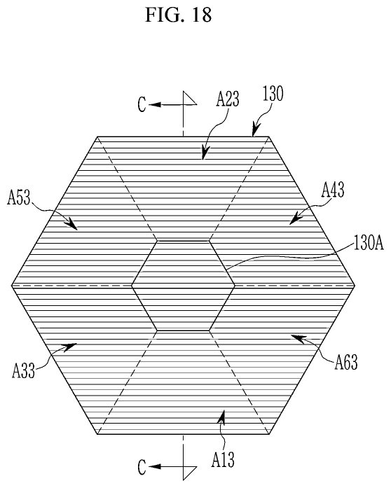

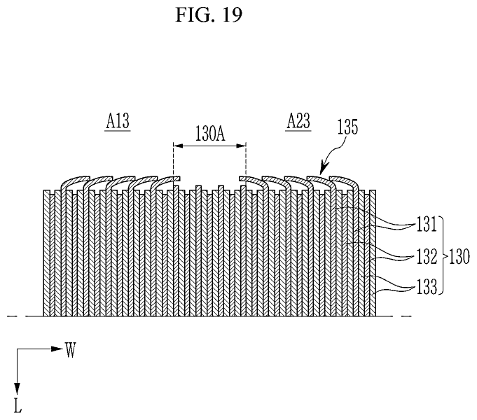

FIG. 18 is a plan view of an electrode assembly of a rechargeable battery according to a sixth embodiment, and FIG. 19 is a cross-sectional view of the electrode assembly cut along a line C-C of FIG. 18. The rechargeable battery of the sixth embodiment may have the same or similar configuration as that of the fifth embodiment described above except for a plurality of tabs to be described below.

Referring to FIG. 18 and FIG. 19, in the rechargeable battery of the sixth embodiment, the plurality of first tabs 135 may be at the remaining region except for a central portion 130A of the electrode assembly 130. In an implementation, the first tabs at the central portion of the electrode assembly may be omitted. The central portion 130A may have various shapes such as a circular shape, a hexagonal shape, or the like on a plane. In FIG. 18, a case in which the central portion 130A has the hexagonal shape is shown as an example.

In a structure in which the first tabs 135 are omitted in the central portion 130A of the electrode assembly 130, it is possible to help suppress a thickness of the plurality of first tabs 135 from increasing in the central portion 130A of the electrode assembly 130 if first to sixth sets of tabs A13, A23, A33, A43, A53, and A63 are bent along first to sixth directions D1-D6. The plurality of first tabs 135 may have a uniform thickness throughout the first to sixth sets of tabs A13, A23, A33, A43, A53, and A63. The plurality of second tabs may have the same configuration as that of the plurality of first tabs 135, and a repeated description thereof may be omitted.

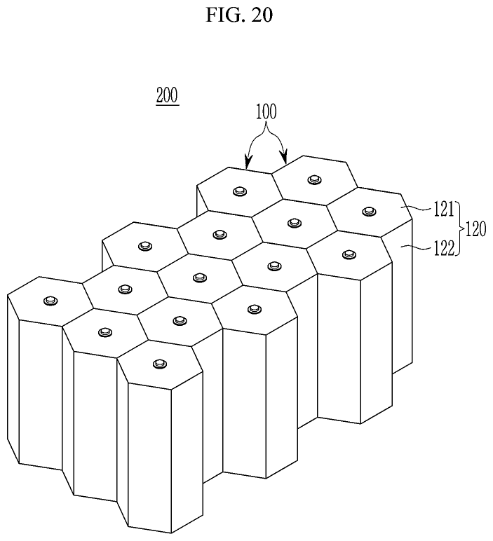

FIG. 20 is a schematic diagram of a battery module according to embodiments.

Referring to FIG. 20, the battery module 200 may include a plurality of rechargeable batteries 100 in which side portions of the can 120 contact each other. The plurality of rechargeable batteries 100 may include any of the first to sixth embodiments described above. The plurality of rechargeable batteries 100 may be in close contact with each other between the side portions 122 of the can 120 without a dead space (or an empty space) by the hexagonal column-shaped can 120.

An empty space could be generated between adjacent rechargeable batteries in a battery module including a plurality of cylindrical rechargeable batteries, but an empty space may not be generated between adjacent rechargeable batteries 100 in the battery module 200 of the present embodiment. The battery module 200 of the present embodiment may have a structure that increases space efficiency, and may be advantageous for increasing output and capacity.

One or more embodiments may provide a hexagonal pillar-type rechargeable battery.

One or more embodiments may provide a rechargeable battery that may increase an output and a capacity of a battery module by increasing integration of a plurality of rechargeable batteries when the battery module is formed by combining the plurality of rechargeable batteries.

According to the embodiments, an electrode assembly may be disposed while minimizing an empty space inside a hexagonal column-shaped can (or a hexagonal pillar-shaped can), so that an output and a capacity of a battery are increased. Because a plurality of tabs are bent to be overlapped with each other, a current collecting efficiency may be increased, and a welding quality between the plurality of tabs and a current collecting plate may be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
a hexagonal column-shaped can that includes a top portion and a side portion;
an electrode assembly in the can and in which a plurality of electrodes having different widths are stacked along a width direction of the rechargeable battery; and
a cap plate that is coupled to an end portion of the side portion and seals the can,
wherein:
the electrode assembly includes a plurality of tabs on at least one side along a length direction of the rechargeable battery, and
the plurality of tabs include a first set of tabs bent in a first direction and a second set of tabs bent in a second direction different from the first direction.

2. The rechargeable battery of claim 1, wherein:
each electrode of the plurality of electrodes has a quadrangular sheet shape,
a long side of each electrode of the plurality of electrodes is parallel to the length direction of the rechargeable battery, and
a short side of each of the plurality of electrodes is parallel to two facing surfaces of six surfaces of the side portion of the can.

3. The rechargeable battery of claim 2, wherein:
two electrodes at an outermost side among the plurality of electrodes have a smallest width,
an electrode at a center has a greatest width, and
widths of the plurality of electrodes gradually increase from the outermost side toward the center.

4. The rechargeable battery of claim 1, wherein:
the second direction is a reverse direction relative to the first direction, and
a width of the first set of tabs along the first direction and a width of the second set of tabs along the second direction are each the same as a width of the electrode assembly.

5. The rechargeable battery of claim 4, wherein:
each tab of the plurality of tabs includes a central cutting groove and a plurality of cutting lines,
the first set of tabs is at one side of the central cutting groove, and
the second set of tabs is at another side of the central cutting groove.

6. The rechargeable battery of claim 4, further comprising a current collecting plate coupled to the plurality of tabs,
wherein the plurality of tabs and the current collecting plate have a hexagonal shape on a plane.

7. The rechargeable battery of claim 1, wherein:
the second direction is a reverse direction relative to the first direction, and
a width of the first set of tabs along the first direction and a width of the second set of tabs along the second direction are each half a width of the electrode assembly.

8. The rechargeable battery of claim 7, wherein a tab of the first set of tabs and a tab of the second set of tabs among the plurality of tabs overlap each other at a boundary portion between the first set of tabs and the second set of tabs.

9. The rechargeable battery of claim 7, wherein:
the plurality of tabs includes at least one tab at a boundary portion of the second set of tabs and contacting the first set of tabs, and
the at least one tab has a protruding length smaller than that of a tab at a remaining portion other than the boundary portion.

10. The rechargeable battery of claim 7, further comprising a current collecting plate coupled to the plurality of tabs,
wherein:
each tab of the plurality of tabs includes a plurality of cutting lines, and
the plurality of tabs and the current collecting plate have a hexagonal shape or a quadrangular shape on a plane.

11. A rechargeable battery, comprising:
a hexagonal column-shaped can that includes a top portion and a side portion;
an electrode assembly in the can and in which a plurality of electrodes having different widths are stacked along a width direction of the rechargeable battery; and
a cap plate that is coupled to an end portion of the side portion and seals the can, wherein:
the electrode assembly includes a plurality of tabs on at least one side along a length direction of the rechargeable battery, and
the plurality of tabs include six sets of tabs, the six sets of tabs being respectively bent in six different directions.

12. The rechargeable battery of claim 11, wherein:
each of the plurality of electrodes has a quadrangular sheet shape,
a long side of each of the plurality of electrodes is parallel to the length direction, and
a short side of each of the plurality of electrodes is parallel to two facing surfaces of the six surfaces of the side portion of the can.

13. The rechargeable battery of claim 12, wherein:
the six different directions are respectively directions extending inwardly from six sides of the electrode assembly toward a center point of the electrode assembly, and
the six sets of tabs are respectively arranged in a triangle connecting two adjacent corners of the six sides of the electrode assembly and the center point of the electrode assembly.

14. The rechargeable battery of claim 13, wherein:
each tab of the plurality of tabs includes a plurality of cutting lines,
the plurality of tabs are vertically bent in two sets of tabs among the six sets of tabs, and
the plurality of tabs are bent in an inclined direction in the remaining four sets of tabs among the six sets of tabs.

15. The rechargeable battery of claim 13, wherein the plurality of tabs are at a region outside of and surrounding a central portion of the electrode assembly.

16. The rechargeable battery of claim 13, further comprising a current collecting plate coupled to the plurality of tabs,
wherein the plurality of tabs and the current collecting plate have a hexagonal shape on a plane.
